(19) United States
(12) Patent Application Publication
(10) Pub. No.: US 2015/0129482 A1
(43) Pub. Date: May 14, 2015

(54) Conical Solid-Liquid Separator

(71) Applicant: Solis Hight-tech Ind. (Shenzhen) Ltd., Shenzhen (CN)

(72) Inventors: Chunhou Li, Shenzhen (CN); Liang Jie, Shenzhen (CN); Hongbiao Dong, Shenzhen (CN); Zhijun Liu, Shenzhen (CN); Jianbin Xiao, Shenzhen (CN); Yafei Duan, Shenzhen (CN); Xiaoyong Jie, Shenzhen (CN); Jiasong Zhang, Shenzhen (CN)

(21) Appl. No.: 14/535,326

(22) Filed: Nov. 7, 2014

(30) Foreign Application Priority Data
Nov. 12, 2013 (CN) 201310562358.9

(51) Int. Cl. B01D 29/085; B01D 29/56

(52) U.S. Cl. CPC B01D 29/085; B01D 29/56
USPC 210/337; 210/460

(57) ABSTRACT

A conical solid-liquid separator includes a separator body, a clean water collection tank and a wastewater collection tank provided at an upper surface of the separator body, a conical sieves provided at the top of the clean water collection tank, an arc cone sheathed on the top of the conical sieves and having an upper end connected an inlet pipe. With the installation of the conical sieves, wastewater flows from the inlet pipe into the arc cone and then passes through the arc cone to disperse the water flow and enters into the conical sieves for filtering. The conical solid-liquid separator and its operating process are simplified to reduce water consumption and improve the processing efficiency. In addition, the conical solid-liquid separator comes with a simple and compact structure and reduces the power consumption significantly.

### CROSS-REFERENCE TO RELATED APPLICATIONS

This non-provisional application claims priority under 35 U.S.C. §119(a) on Patent Application No(s). 201310562358.9 filed in China on Nov. 12, 2013, the entire contents of which are hereby incorporated by reference.

### BACKGROUND OF THE INVENTION

1. Field of the Invention

The present invention relates to an apparatus for separating a solid and a liquid in wastewater during a water treatment process, and the apparatus is applicable for raw water treatment, wastewater treatment, and fish/shrimp factory farming.

2. Description of the Related Art

In the fields of factory aquaculture and water treatment, solid-liquid separation is a common process, and the effect of this process directly relates to the workload and processing efficiency of the follow-up processes. In water treatment process, particularly the solid-liquid separation of wastewater for fish/shrimp factory aquaculture, common equipments used in such process include filters, arc sieves, microfiltration machines, etc. However, these common equipments have the following existing problems: (1) Low processing efficiency; (2) High power consumption; and (3) Troublesome cleaning and complicated maintenance.

### SUMMARY OF THE INVENTION

In view of the aforementioned problems of the prior art, it is a primary objective of the present invention to provide a conical solid-liquid separator to overcome the problems of the prior art.

To achieve the aforementioned objective, the present invention provides a conical solid-liquid separator, comprising: a separator body containing a clean water collection tank provided therein; a wastewater collection tank provided around an outer layer of the clean water collection tank; a plurality of conical sieves provided at the top of the clean water collection tank; and an arc cone sheathed on the top of the conical sieves and having an upper end coupled to an inlet pipe.

In a preferred embodiment, an influent channel is formed between an inner wall of the arc cone and an outer wall of the top of the most outer layer of the conical sieves, and an entrance of the influent channel has a cross-sectional area greater than a cross-sectional area of an exit of the influent channel.

In a preferred embodiment, a contact area between an upper end of the arc cone and an upper end of the most outer layer of the conical sieves has a spiral structure, the spiral structure comprises a screw rod or a screw hole that are provided on the arc cone, and a screw hole or a screw rod that are provided on the most outer layer of the conical sieves.

In a preferred embodiment, the conical sieves at the upper layers have an inclosing area larger than that of the conical sieves at the lower layers.

In a preferred embodiment, the clean water collection tank has a drain outfall provided on an outer wall of the bottom of the clean water collection tank, and the drain outfall is provided with a curve drain pipe or a straight drain pipe, and a sewage outfall is provided on a sidewall of the wastewater collection tank.

In a preferred embodiment, the most outer layer of the conical sieves is provided with a diffluent structure.

The present invention has the following advantages and effects: With the installation of the conical sieves in accordance with the present invention, wastewater flows from the inlet pipe into the arc cone, and passes through the arc cone to disperse the water flow before entering into the conical sieves for filtration, and thus the invention simplifies the solid-liquid separator and operating process to achieve the effects of reducing the hydraulic loss and improving the processing efficiency. In addition, the invention comes with a simple and compact structure to reduce the power consumption significantly.

### BRIEF DESCRIPTION OF THE DRAWINGS

FIG. 1 is a schematic view of a conical solid-liquid separator of the present invention;

FIG. 2 is an exploded view of a conical solid-liquid separator of the present invention;

FIG. 3 is a cross-sectional view of a conical solid-liquid separator of the present invention;

FIG. 4 is a schematic view of a spiral structure of the present invention; and

FIG. 5 is a schematic view of a conical solid-liquid separator having a plurality of conical sieves in accordance with the present invention.

### DETAILED DESCRIPTION OF THE PREFERRED EMBODIMENTS

The aforementioned and other objectives, technical characteristics and advantages of the present invention will become apparent with the detailed description of preferred embodiments and the illustration of related drawings as follows.

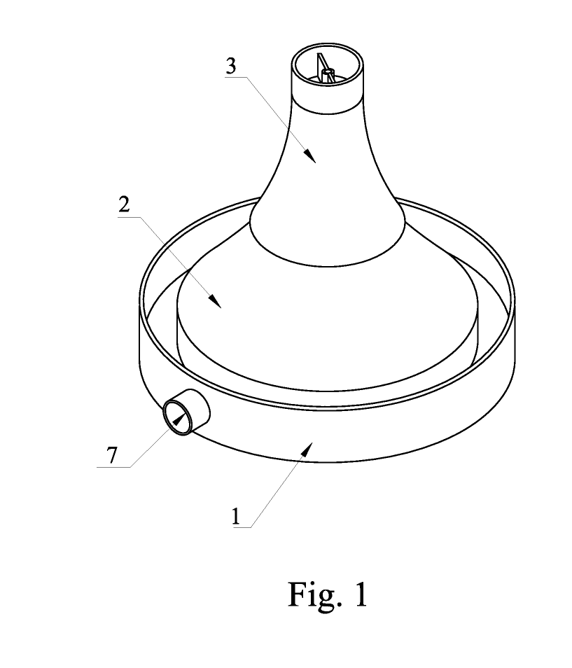

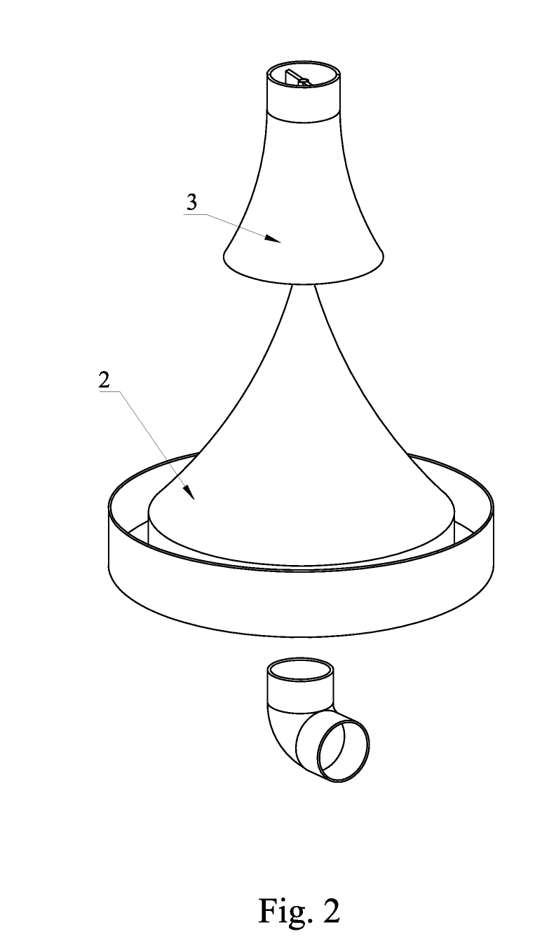

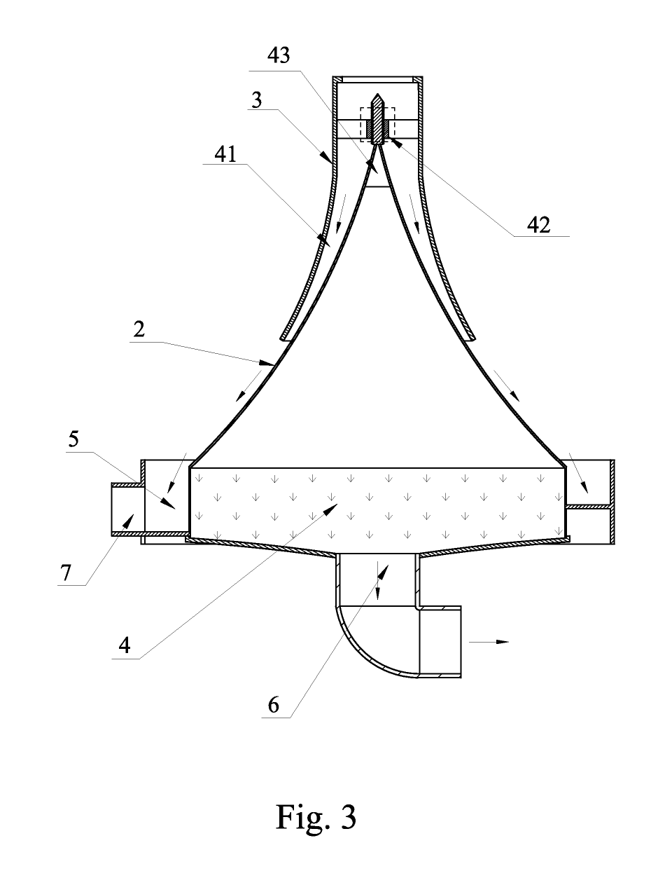

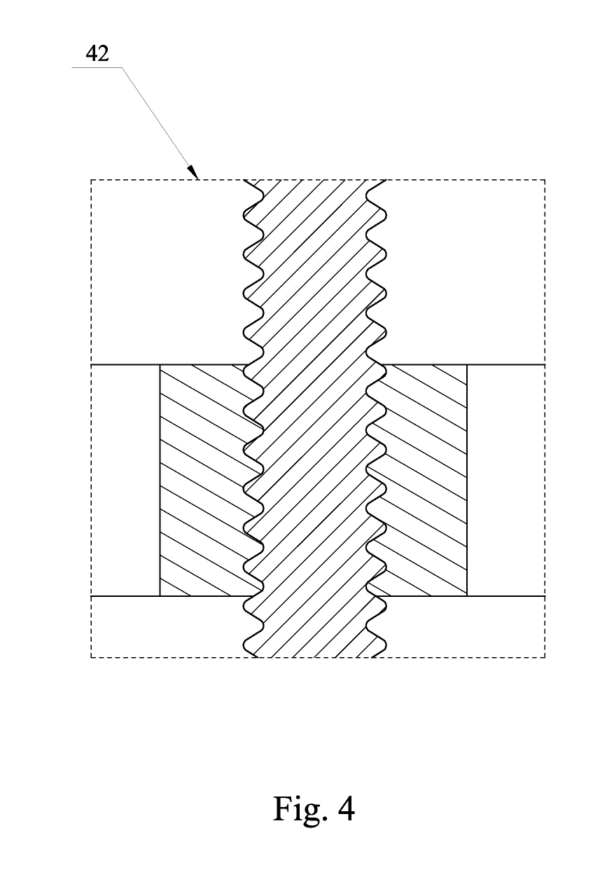

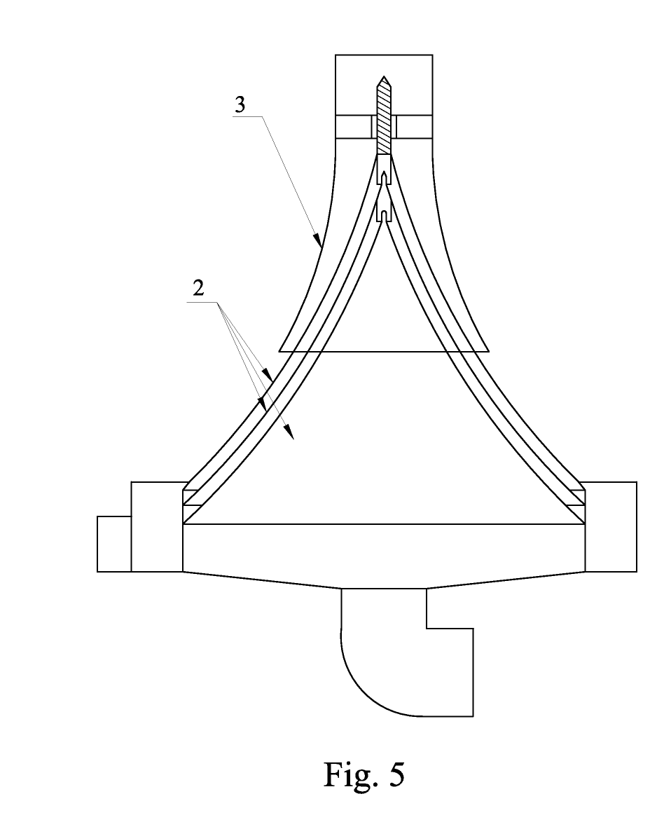

With reference to FIGS. 1 to 5 for a conical solid-liquid separator of the present invention, the conical solid-liquid separator comprises a separator body 1; a clean water collection tank 4 provided in the separator body 1; a ring shaped wastewater collection tank 5 provided at the outer surface of the water collection tank 4; one or more conical sieves 2 provided at the top of the clean water collection tank 4, and a hollow arc cone 3 sheathed on the top of the conical sieves 2 and having an upper end coupled to an inlet pipe.

With the installation of the conical sieves 2, wastewater flows from the inlet pipe into the arc cone 3 and passes through the arc cone 3 to be dispersed before entering into the conical sieves 2 for filtration. The invention simplifies the solid-liquid separator and operating process to achieve the effects of reducing the hydraulic loss and improving the processing efficiency. In addition, the invention comes with a simple and compact structure to reduce the power consumption significantly.

In a preferred embodiment, an influent channel 41 is formed between an inner wall of the arc cone 3 and an outer wall of the top of the most outer layer of the conical sieves 2, and an entrance of the influent channel 41 has a cross-sectional area greater than a cross-sectional area of an exit of the influent channel 41, so that the cross-sectional area is decreased gradually to facilitate stabilizing the pressure and flow of the water. As the cross sectional area of the water flow increases, the water flow rate decreases, and the pressure at the bottom end of the arc cone 3 decreases gradually.

So that a user can utilize a spiral structure 42 provided between the upper end of the arc cone 3 and the most outer layer of the conical sieves 2 to adjust the distance between the arc cone 3 and the conical sieves 2 so as to adjust the flow velocity or pressure of the flowing water, and further promote the separation of solid and liquid.

In a preferred embodiment, a spiral structure 42 is provided at a contact area between an upper end of the arc cone and an upper end of the most outer layer of the conical sieves. The spiral structure 42 comprises a screw rod or a screw hole that are provided on the arc cone 3, and a screw hole or a screw rod that are provided on the most outer layer of the conical sieves 2. A user can use the spiral structure 42 provided on the arc cone 3 and the most outer layer of the conical sieves 2 to adjust the distance between the arc cone 3 and the conical sieves 2 to adjust the flow velocity or pressure of the flowing water, and further promote the separation of solid and liquid.

In another preferred embodiment of the present invention, a receiving area of the upper layer conical sieves 2 is larger than that of the conical sieves 2 which is covered underneath. When a plurality of conical sieves 2 is implanted, conical sieves 2 having increase receiving area are stacked from bottom to top, such that the water is filtered by passing through a plurality of conical sieves 2 to enhance filtering result.

In another preferred embodiment of the present invention, a drain outfall 6 is provided on an outer wall of the bottom of the clean water collection tank 4 and provided for connecting a drain pipe, wherein the drain pipe may be a curved drain pipe or a straight drain pipe connected by users according to the required installation position. Through the drain outfall 6 and the drain pipe, the filtered water is sent to the next process, and the wastewater collection tank 5 has a sewage outfall 7 provided on a sidewall of the wastewater collection tank 5, and the collected and filtered wastewater is processed through the sewage outfall 7.

In another preferred embodiment of the present invention, wherein the most outer layer of the conical sieve 2 is provided with a diffluent structure 43 that diverts water so that the processed water can flow steadily into the influent channel 41.

While the invention has been described by means of specific embodiments, numerous modifications and variations could be made thereto by those skilled in the art without departing from the scope and spirit of the invention set forth in the claims.

What is claimed is:

1. A conical solid-liquid separator, comprising:
a separator body;
a clean water collection tank, provided within the separator body;
a wastewater collection tank, provided around an outer layer of the clean water collection tank, the wastewater collection tank being ring shaped;
one or more conical sieves, provided at the top of the clean water collection tank; and
an arc cone, the arc cone being hollow and sheathed on the top of the conical sieves and having an upper end coupled to an inlet pipe.

2. The conical solid-liquid separator of claim 1, wherein an influent channel is formed between an inner wall of the arc cone and an outer wall of the top of the most outer layer of the conical sieves, and an entrance of the influent channel has a cross-sectional area greater than a cross-sectional area of an exit of the influent channel.

3. The conical solid-liquid separator of claim 1, wherein a contact area between an upper end of the arc cone and an upper end of the most outer layer of the conical sieves has a spiral structure, the spiral structure comprises a screw rod or a screw hole that are provided on the arc cone, and a screw hole or a screw rod that are provided on the most outer layer of the conical sieves.

4. The conical solid-liquid separator of claim 1, wherein the conical sieves at the upper layers has an inclosing area larger than that of the conical sieves at the lower layers.

5. The conical solid-liquid separator of claim 2, wherein the conical sieves at the upper layers has an inclosing area larger than that of the conical sieves at the lower layers.

6. The conical solid-liquid separator of claim 3, wherein the conical sieves at the upper layers has an inclosing area larger than that of the conical sieves at the lower layers.

7. The conical solid-liquid separator of claim 1, wherein the clean water collection tank has a drain outfall provided on an outer wall of the bottom of the clean water collection tank, and the drain outfall is provided with a curve drain pipe or a straight drain pipe, and a sewage outfall is provided on a sidewall of the wastewater collection tank.

8. The conical solid-liquid separator of claim 2, wherein the clean water collection tank has a drain outfall provided on an outer wall of the bottom of the clean water collection tank, and the drain outfall is provided with a curve drain pipe or a straight drain pipe, and a sewage outfall is provided on a sidewall of the wastewater collection tank.

9. The conical solid-liquid separator of claim 3, wherein the clean water collection tank has a drain outfall provided on an outer wall of the bottom of the clean water collection tank, and the drain outfall is provided with a curve drain pipe or a straight drain pipe, and a sewage outfall is provided on a sidewall of the wastewater collection tank.

10. The conical solid-liquid separator of claim 1, wherein the most outer layer of the conical sieves is provided with a diffluent structure.

11. The conical solid-liquid separator of claim 2, wherein the most outer layer of the conical sieves is provided with a diffluent structure.

12. The conical solid-liquid separator of claim 3, wherein the most outer layer of the conical sieves is provided with a diffluent structure.
